(19) United States
(12) Patent Application Publication
(10) Pub. No.: US 2005/0273830 A1
(43) Pub. Date: Dec. 8, 2005

(54) Interactive broadcast system

(75) Inventors: Yonatan Silver, Jerusalem (IL); Ezra Darshan, Beit Shemesh (IL)

Correspondence Address: WELSH & KATZ, LTD, 120 S RIVERSIDE PLAZA, 22ND FLOOR, CHICAGO, IL, 60606, US

(73) Assignee: NDS LIMITED, Staines (GB)

(21) Appl. No.: 10/529,561

(22) PCT Filed: Oct. 2, 2003
(86) PCT No.: PCT/IL03/00796

§ 371 Date: May 27, 2005

Related U.S. Application Data
(60) Provisional application No. 60/422,348, filed on Oct. 30, 2002.

(51) Int. Cl. H04N 7/173

(52) U.S. Cl. 725/105

(57) ABSTRACT

An anticipatory processing system is described. The anticipatory processing system includes a controller generating a prediction of an event determining program material to be displayed, and an audiovideo (A/V) processor controlled by the controller for preparing a digital stream for use in response to the prediction of the of the event. Related apparatus and methods are also described.

### CROSS-REFERENCE TO RELATED APPLICATIONS

The present application claims priority from U.S. Provisional Patent Application Ser. No. 60/422,348, filed 30 Oct. 2002, the disclosure of which is hereby incorporated herein by reference.

### FIELD OF THE INVENTION

The present invention generally relates to interactive systems such as, for example, interactive broadcast systems.

### BACKGROUND OF THE INVENTION

In digital broadcast systems, such as digital cable television systems and direct broadcast satellite systems, there is typically a noticeable delay each time a viewer changes a channel. A noticeable delay also occurs before an advertisement is displayed at a commercial break in a program viewed on a channel, particularly in interactive television applications and applications that use personal video recorders (PVRs) in which advertisements may be personally manipulated and selectively displayed.

Such delays are typically due to processing time required for tuning and processing digital channels and for preparing information for display on digital channels. Reduction of such delays is considered desired for improving the viewing experience of a user of a digital broadcast system, particularly when the user utilizes interactive applications in which smooth advertisement display and smooth transition between channels are required.

Technologies that may be useful in understanding the present invention exist in various fields. For example, there are web sites, such as museum web sites, that allow multiple visitors to each take an individual “virtual tour” of a virtual museum and/or manipulate exhibits in the virtual museum. In such a case, viewers are simply seeing a pre-generated series of still images of the museum and/or its exhibits.

In other related technologies that refer to web sites, commercial software products, such as Internet Explorer by Microsoft® Corporation, download links onto a user's PC, and work on retrieval of a linked item, e.g., a next page, may begin before selection of the link for that page is made. Web cameras (webcams) are used at web sites to enable viewers accessing the web sites to view pictures and video provided thereby.

In computer games, data available to a player may be dependent upon his current “location” within the game. Determination and transmission of a location of a user, particularly via a cellular telephone is known in cellular telephony. Cellular telephones are also known that transmit and receive video. Determination of a caller identification is used in Caller ID systems. Determination of associates of a user being on-line together with the user is used in software products such as ICQ and Yahoo Messenger.

A description in a world-wide-web (WWW) site of Albatrossdesign.com at www.albatrossdesign.com/products/panorama refers to a product named ADG Panorama Tools 4.0. This product is a program that lets a user to quickly and easily generate, edit & embed publish 360 degrees interactive panoramic composition on the web from a series of photos. The term “interactive” as used in the description of the product may refer to the ability of the user of the program to rotate through a 360-degree view that is pre-generated from a series of still photos. The program does not deal with live transmission of images, where the view constantly changes not only with respect to camera angle, but also with time.

The widely-used MPEG-2 system is described, for example, in: a) ISO/IEC 13818-1; and b) Haskell et al, Digital video: An Introduction to MPEG-2; New York, Chapman & Hall, 1997. The widely-used MPEG-4 system is described, for example, in ISO/IEC 14496.

U.S. Pat. No. 5,600,368 to Matthews describes a plurality of cameras at an event that allow a viewer to switch between discrete camera views. Keys on the remote unit are arranged in a pattern that corresponds to the various camera views available.

U.S. Pat. No. 4,062,045 to Iwane describes production of 3D images by means of a plurality of TV cameras.

U.S. Pat. No. 4,931,817 to Morioka describes improvement in a process for producing works of sculpture.

U.S. Pat. No. 5,448,291 to Wickline describes a multiplicity of cameras, each of which produces a distinct image on a separate screen (e.g., screens placed above the stage in a theatre).

U.S. Pat. No. 5,659,323 to Taylor describes effects that can be produced prior to broadcast by having an arrangement of a multiplicity of cameras.

U.S. Pat. No. 5,703,961 to Rogina et al describes synthesis of images from a multiplicity of cameras to allow a viewer to change the angle of view when he moves his head.

U.S. Pat. No. 6,359,647 B1 to Sengupta describes automation of a multiple-camera system based upon the location of a target object in a displayed camera image.

U.S. Pat. No. 6,373,508 B1 to Moengen describes path of a (moving) object within a picture. Also described is replacing, prior to or during the broadcast, the display of a tracked object with another (e.g. more clearly visible) object.

U.S. Pat. No. 5,714,997 to Anderson describes a virtual-reality TV system that allows a viewer to select viewpoints of a scene, and to receive sounds as they would be heard at that point.

U.S. Pat. No. 5,729,471 to Jain et al describes machine dynamic selection of one video camera/image of a scene from multiple video cameras/images of the scene in accordance with a particular perspective on the scene, an object in the scene, or an event in the scene.

U.S. Pat. No. 5,745,126 to Jain et al describes machine synthesis of a virtual video camera/image of a scene from multiple video cameras/images of the scene in accordance with a particular perspective on the scene, an object in the scene, or an event in the scene.

U.S. Pat. No. 5,850,352 to Moezzi et al describes “hypermosaicing” of multiple video perspectives on a scene; detecting and tracking objects, and production of a 3D dynamic model—from which selectively synthesized 2D video images can be generated.

U.S. Pat. No. 6,144,375 to Jain et al describes a content-based interactive video query system, e.g., home runs hit by a specific player, request to view via a sensor next to the bookshelf. Only the video events of interest are transmitted over the transmission network. Also described is motion detection which is achieved, e.g., by providing an event timeline or allowing viewer interaction with a 2D video window. The material is recorded and maintained by an interactive multimedia system.

U.S. Pat. No. 6,154,251 to Taylor describes an array of cameras, with the output of each recorded in advance and arranged to produce a virtual camera. Allows effects such as freeze of the actual motion within a scene while allowing the illusion of camera movement with respect to the frozen scene. A ‘motion blur’ could be employed to smooth the human-eye view of the transition from frame to frame.

U.S. Pat. No. 6,327,381 B1 to Rogina et al describes pixel data elements of a picture produced e.g., by several cameras on a spherical locus, and viewed e.g., from within a cave.

U.S. Pat. No. 6,396,403 describes use of GPS and a camera to monitor a child.

Published PCT Patent Application WO 00/01149 of NDS Limited describes a digital television recording method including broadcasting a television program, operating an agent for determining whether to record the program, storing the program, and retrieving at least part of the program for display. Access to predetermined portions of the program may be determined by a user set of parameters. The program may be edited to include the user set of parameters, which then may be stored as part of the program. A commercially available system based on the invention of PCT Patent Application WO 00/01149, known as “XTV”, is commercially available from NDS Limited, One London Road, Staines, Middlesex, TW184EX, United Kingdom.

The disclosures of all references mentioned above and throughout the present specification, as well as the disclosures of all references mentioned in those references, are hereby incorporated herein by reference.

### SUMMARY OF THE INVENTION

The present invention seeks to provide improved utilization of interactive applications by improving control of insertion of advertisements and other audio and/or video material and user control of channel changing and scene viewing in broadcast programs.

In digital broadcast systems, such as digital cable television systems and digital satellite systems, channel changing by a user and insertion of audio and/or video (A/V) material such as advertisement material are typically accompanied by noticeable delays that adversely affect viewing experience and use of interactive applications that require many advertisement insertions and many transitions between channels. In the present invention, an anticipatory processing system is used to smooth insertion of A/V material, for example and without limiting the foregoing, for advertisement display, and to smooth channel changing and thereby to improve the viewing experience of users. The anticipatory processing system may also preferably smooth A/V material insertion, advertisement display and channel changing in analog broadcast systems.

Additionally, display apparatus is used for marking an object of interest, such as a person, on a display for enabling the user to track the object of interest.

The term “regular channel” is used throughout the present specification and claims to refer to a channel that a viewer accesses by performing regular channel changing activities. The term “virtual channel” is used throughout the present specification and claims to refer to a channel that is associated with a regular channel, and is accessible via the regular channel. For example, a viewer may press appropriate channel changing buttons on a remote control to access a regular channel that displays a baseball game. Associated with the regular channel may be virtual channels, such as channels that provide different camera views of the game. The virtual channels that provide the different camera views of the game are preferably accessible once the viewer is viewing the regular channel.

It is appreciated that any regular channel may have a number of virtual channels associated with it. A regular channel may additionally or alternatively solely comprise a number of virtual channels.

There is thus provided in accordance with a preferred embodiment of the present invention an anticipatory processing system including a controller generating a prediction of an event determining program material to be displayed, and an audio/video (A/V) processor controlled by the controller for preparing a digital stream for use in response to the prediction of the event.

Preferably, the A/V processor is also controlled by the controller for preparing A/V information associated with the program material for display in association with the digital stream in response to the prediction of the event.

The A/V processor preferably prepares the digital stream for use by performing at least one of the following: preparing the digital stream for rendering, preparing the digital stream for storage, and preparing the digital stream for distribution via a communication network.

Additionally, the system also includes a display unit displaying the A/V information associated with the program material in association with the digital stream if the event occurs.

Preferably, the A/V processor, operating under control of the controller, uses the digital stream at a time after termination of preparation of the digital stream for use if the event occurs. The time after termination of preparation of the digital stream for use may be immediately after termination of preparation of the digital stream for use.

The event preferably includes at least one of the following: user input, an indication of a commercial break, an instruction from a headend or a broadcast source, an instruction from a computer program predicting user behavior based on a user profile, an alert associated with a current display, and at least one message from a broadcaster or a service provider.

Preferably, the program material includes a commercial. Alternatively, the program material includes a segment of a television program.

The digital stream is preferably associated with a channel. The channel preferably includes one of the following: a regular channel, and a virtual channel.

Preferably, the A/V processor prepares the A/V information for display in association with the digital stream by performing at least one of the following: preparing the A/V information for display over a channel associated with the digital stream, preparing the A/ V information for display together with the digital stream in a picture-in-picture (PIP) mode, and preparing the A/V information for display together with the digital stream in a side-by-side mode.

There is also provided in accordance with a preferred embodiment of the present invention an anticipatory processing system including a controller generating a prediction of an event determining program material to be displayed, and a tuner controlled by the controller for preparing an analog channel for use in response to the prediction of the event. The analog channel preferably includes an analog television channel.

Preferably, the tuner is also controlled by the controller for preparing A/V information associated with the program material for display over the analog channel in response to the prediction of the event.

Further preferably, the tuner uses the analog channel if the event occurs.

In accordance with another preferred embodiment of the present invention there is provided an anticipatory processing system including a plurality of A/V processors including at least a first A/V processor and a second A/V processor, and a controller controlling at least the first A/V processor and the second A/V processor and, upon the first A/V processor rendering or preparing for rendering a first digital stream, instructing the second A/V processor to prepare a second digital stream for rendering based, at least in part, on predicted input.

Preferably, the controller generates the predicted input based upon at least one of the following: user input, an indication of rendering or preparation for rendering of the first digital stream, an indication of a commercial break, an instruction from a headend or a broadcast source, an instruction from a computer program predicting user behavior based on a user profile, an alert associated with a current display, and at least one message indicating current or scheduled occurrence of an event.

The controller preferably includes a stream selector for choosing any one of the first digital stream and the second digital stream from at least one of the following: a broadcast multiplex, and a plurality of digital content items stored in a memory.

Preferably, the second A/V processor, operating under control of the controller, renders the second digital stream after termination of preparation of the second digital stream for rendering if the predicted input is actually inputted.

Still preferably, each of the plurality of A/V processors includes a decoder for decoding an encoded data stream. The encoded data stream preferably includes an encoded video stream. Preferably, the encoded video stream includes an MPEG data stream and the decoder includes an MPEG decoder.

The MPEG data stream may preferably include an MPEG-2 data stream in which case the MPEG decoder preferably includes an MPEG-2 decoder. Alternatively, the MPEG data stream may include an MPEG-4 data stream and the MPEG decoder may include an MPEG4 decoder.

Preferably, the anticipatory processing system also includes a display unit operative to display at least one of the following: audio content, and video content. The audio content preferably includes audio content outputted by the first A/V processor and the video content preferably includes video content outputted by the first A/V processor. The display unit may also preferably display video content outputted by the second A/V processor as picture-in-picture (PIP) images.

Additionally, the system also includes a content storage unit operative to store at least one of the following: audio content, and video content. The audio content stored by the content storage unit may preferably include audio content outputted by the second A/V processor and the video content stored by the content storage unit may preferably include video content outputted by the second A/V processor.

Preferably, the controller retrieves from the content storage unit for display at least one of the following: audio content, and video content.

The user input preferably includes user channel changes. The user channel changes preferably include a channel change in a first direction, and the predicted input is one of the following: a channel change in the first direction, and a channel change in a direction opposite to the first direction. Preferably, the first direction includes exactly one of the following: an upward direction, and a downward direction.

The user channel changes preferably include changes between exactly one of the following: virtual channels, and regular channels.

Preferably, the controller determines at least one favorite channel based, at least in part, on the predicted input.

The controller may also preferably track a discrete object based, at least in part, on information concerning a path of the object. The discrete object preferably includes a person. The person preferably includes one of the following: an actor, a player, and an audience member.

Preferably, the controller tracks the person only upon receipt of an indication of at least one of the following: knowledge of the person, and permission of the person. The system may also preferably include a processor receiving the indication from at least one of the following: the person directly, a broadcast source, and a headend.

The indication is preferably generated from an authorization list of parties with permission to track the person that is provided by the person, wherein the indication is generated at one of the following: the broadcast source, and the headend.

Preferably, the controller tracks the discrete object by processing images received from a plurality of cameras that together provide a panoramic view of the object, wherein each camera of the plurality of cameras provides a viewing range which is a subset of the panoramic view.

The controller preferably includes a special-effects generator for locally producing special effects.

Each of the anticipatory processing systems mentioned above may be comprised in a cellular telephone.

There is also provided in accordance with a preferred embodiment of the present invention display apparatus for marking an object of interest on a display, the apparatus including an object determiner determining the object of interest based, at least in part, on user input, a position information receiver receiving, from a source remote to the display apparatus, information defining a position of the object of interest within a displayed picture, and an on-screen display (OSD) unit displaying a visible indicator at a display position on the display, the display position being based, at least in part, on the position of the object of interest. The apparatus may preferably be comprised in a set-top box (STB), where the STB is preferably associated with at least one particular viewer who is authorized to view the object of interest, and is operative to receive the information via a telephone message.

Preferably, the information is sent from a broadcast source or a headend. The information is preferably addressed to at least one particular viewer.

The object of interest is preferably operatively associated with identification (ID). Preferably, the object of interest includes a person. The person preferably includes one of the following: an actor, a player, and an audience member.

The position information receiver may preferably receive the information from the source remote to the display apparatus only upon generation of an indication of at least one of the following: knowledge of the person, and permission of the person. The indication is preferably generated at the source from an authorization list of parties with permission to track the person that is provided by the person.

Alternatively, the position information receiver may receive via the source a permission from the person to be tracked.

Further alternatively, the position information receiver may receive an indication of a permission to be tracked directly from the person.

There is also provided in accordance with a preferred embodiment of the present invention an anticipatory processing method including predicting an event determining program material to be displayed, and preparing a digital stream for use in response to the predicting.

Additionally, the method also includes preparing A/V information associated with the program material for display in association with the digital stream in response to the predicting.

The step of preparing the digital stream for use may preferably include preparing the digital stream for rendering.

Alternatively, the step of preparing the digital stream for use may include preparing the digital stream for storage.

Further alternatively, the step of preparing the digital stream for use may include preparing the digital stream for distribution via a communication network.

The method additionally includes the step of using the digital stream if the event occurs. The step of using preferably includes at least one of the following: rendering the digital stream, storing the digital stream, and distributing the digital stream. The rendering preferably includes rendering the digital stream at a time after termination of preparation of the digital stream for use. The time after termination of preparation of the digital stream for use may be immediately after termination of preparation of the digital stream for use.

Preferably, the step of preparing A/V information for display in association with the digital stream includes at least one of the following: preparing the A/V information for display over a channel associated with the digital stream, preparing the A/V information for display together with the digital stream in a PIP mode, and preparing the A/V information for display together with the digital stream in a side-by-side mode.

Further in accordance with a preferred embodiment of the present invention there is provided an anticipatory processing method including predicting an event determining program material to be displayed, and preparing an analog channel for use in response to the predicting.

Additionally, the method also includes preparing A/V information associated with the program material for display over the analog channel in response to the predicting.

Further additionally, the method also includes using the analog channel if the event occurs. The step of using preferably includes at least one of the following: rendering the analog channel over a television display, and recording the program material in a VCR.

In accordance with another preferred embodiment of the present invention there is provided an anticipatory processing method including providing a plurality of A/V processors including at least a first A/V processor and a second A/V processor, and instructing the second A/V processor, upon the first A/V processor rendering or preparing for rendering a first digital stream, to prepare a second digital stream for rendering based, at least in part, on predicted input.

Additionally, the method also includes rendering the second digital stream if the predicted input is actually inputted.

Also in accordance with a preferred embodiment of the present invention there is provided a display method for marking an object of interest on a display, the method including determining the object of interest based, at least in part, on user input, receiving information defining a position of the object of interest within a displayed picture, and displaying a visible indicator at a display position on the display, the display position being based, at least in part, on the position of the object of interest.

### BRIEF DESCRIPTION OF THE DRAWINGS

The present invention will be understood and appreciated more fully from the following detailed description, taken in conjunction with the drawings in which:

FIG. 1 is a simplified partly pictorial partly block diagram illustration of a preferred implementation of an interactive broadcast system constructed and operative in accordance with a preferred embodiment of the present invention;

FIG. 2 is a simplified block diagram illustration of a preferred implementation of an anticipatory processing system in the interactive broadcast system of FIG. 1;

FIG. 3 is a simplified partly pictorial partly block diagram illustration of a preferred implementation of a game application in the interactive broadcast system of FIG. 1;

FIG. 4 is a simplified partly pictorial partly block diagram illustration of another preferred implementation of the game application depicted in FIG. 3;

FIG. 5 is a simplified partly pictorial partly block diagram illustration of an arrangement of cameras in a 3-Dimensional application;

FIG. 6 is a simplified block diagram illustration of a preferred implementation of display apparatus in the interactive broadcast system of FIG. 1;

FIG. 7 is a simplified flowchart illustration of a preferred method of operation of the system of FIG. 2;

FIG. 8 is a simplified flowchart illustration of another preferred method of operation of the system of FIG. 2;

FIG. 9 is a simplified flowchart illustration of still another preferred method of operation of the system of FIG. 2; and

FIG. 10 is a simplified flowchart illustration of a preferred method of operation of the display apparatus of FIG. 6.

### DETAILED DESCRIPTION OF A PREFERRED EMBODIMENT

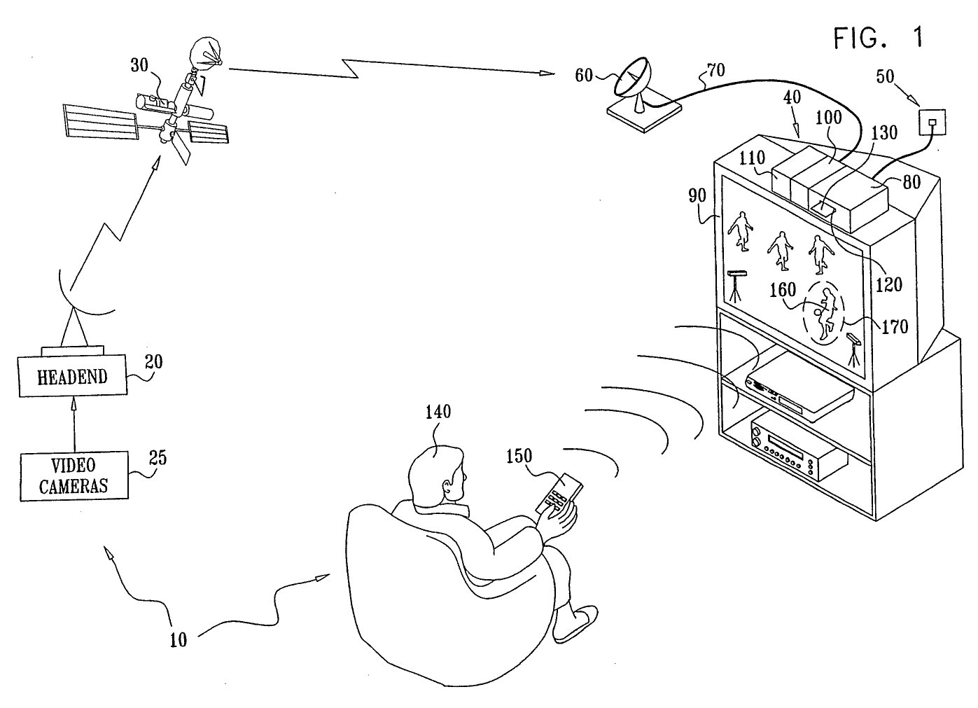

Reference is now made to FIG. 1 which is a simplified partly pictorial partly block diagram illustration of a preferred implementation of an interactive broadcast system 10 constructed and operative in accordance with a preferred embodiment of the present invention.

The interactive broadcast system 10 preferably includes a mass-media communication system which provides to a plurality of subscribers at least one of the following: television programming including pay and/or non-pay television programming; multimedia information; audio programs; data; games; and information from computer based networks such as the Internet.

The system 10 may be implemented via one-way or two-way communication networks that may include at least one of the following: a satellite based communication network; a cable or a CATV (Community Antenna Television) based communication network; a conventional terrestrial broadcast television network; a telephone based communication network; and a computer based communication network. It is appreciated that the system 10 may also be implemented via one-way or two-way hybrid communication networks, such as combination cable-telephone networks, combination satellite-telephone networks, combination satellite-computer based communication networks or by any other appropriate network.

Physical links in any of the one-way or two-way networks may be implemented via optical links, conventional telephone links, radio frequency (RF) wired or wireless links, or any other suitable links.

By way of example, the system 10 is depicted in FIG. 1 as a combination satellite-telephone network in which a headend 20, or a broadcast source including, for example, a plurality of cameras 25, broadcasts program transmissions via a satellite 30 to a plurality of subscriber units. The plurality of cameras 25 may typically be placed to capture an event such as a sports game.

The broadcast source may broadcast the program transmissions either via the headend 20 or via other appropriate means, such as broadcasting equipment of a local broadcaster (not shown). By way of example, the cameras 25 in FIG. 1 are video cameras that transmit program transmissions via the headend 20.

For simplicity of description, only one subscriber unit 40 is illustrated in FIG. 1. A telephone link 50 is preferably used for upstream communication with the headend 20. The telephone link 50 may also be used for individualized downstream communication in which the headend 20 transmits individually addressed information to the subscriber unit 40. Alternatively, the individually addressed information may be transmitted to the subscriber unit 40 via the satellite 30. It is appreciated that if the system 10 is implemented via a cable based communication network, a cable return path may alternatively be used for upstream communication.

The program transmissions broadcast from the headend 20 or via the headend 20 may preferably include all types of television programming including interactive television programming and pay television programming. The program transmissions may alternatively or additionally include at least one of the following; multimedia information; audio programs; data; and gaming information.

At the subscriber unit 40, the program transmissions are preferably received at an antenna 60 and provided via a cable 70 to a user interface unit that preferably comprises a set-top box (STB) 80. The STB 80 preferably prepares the information in a format suitable for display on an appropriate display 90 that may include, for example, a television display or a computer monitor.

The STB 80 preferably includes conventional circuitry (not shown) and the following additional elements: an anticipatory processing system 100; and display apparatus 110. The STB 80 may also preferably include a slot 120 for accepting a smart card 130 for controlling access to services as is well known in the art. It is appreciated that each of the anticipatory processing system 100 and the display apparatus 110 may alternatively be a stand-alone unit or be at least partially comprised in other devices.

In operation, a user 140 may preferably operate a remote control (RC) 150 to select a program for viewing and to change channels as is well known in the art. The anticipatory processing system 100 is preferably used, inter alia, to smooth insertion of A/V material, for example and without limiting the foregoing, for advertisement display, and to smooth transitions between channels and thereby to improve the viewing experience of the user 140. For example, the anticipatory processing system 100 enables the user 140 to comfortably switch between various scenes of a program transmission and to select different viewing angles of an event in the program. The anticipatory processing system 100 also enables, for example, smooth insertion of selected advertisements so that each advertisement may be viewed starting from its first frame and without losing frames due to channel processing delays.

By way of example, in FIG. 1 the program being displayed on the display 90 is an interactive sports game in which the user 140 may switch between different viewing angles of the game. The anticipatory processing system 100 preferably smoothes transitions between channels showing the different viewing angles of the game in accordance with selections made by the user 140.

The display apparatus 110 is preferably used for marking an object of interest, such as a person, on the display 90 to enable tracking of the object of interest by the user 140. If, for example, the object of interest is a person such as a player 160 in the game, a visible indicator 170 may be displayed on the display 90 at a display position, where the display position is based, at least in part, on the position of the object of interest. The user 140 may track the player 160, for example, by tracking the visible indicator 170.

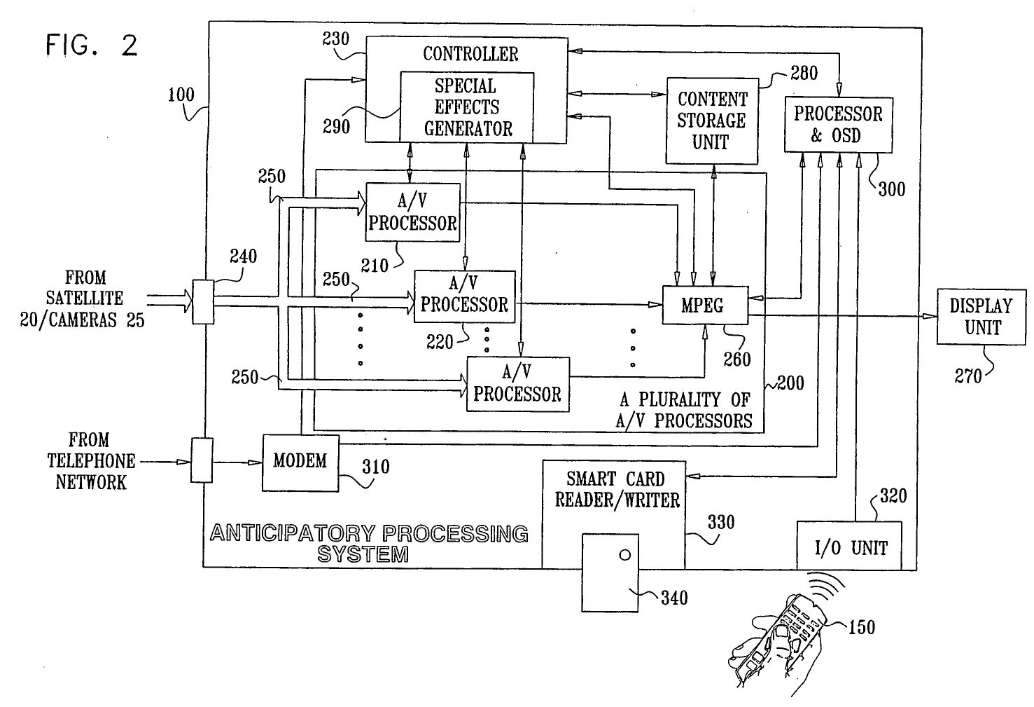

Reference is now additionally made to FIG. 2 which is a simplified block diagram illustration of a preferred implementation of the anticipatory processing system 100 in the interactive broadcast system 10 of FIG. 1.

Preferably, the anticipatory processing system 100 includes a plurality of audio/video (A/V) processors 200 comprising at least a first A/V processor 210 and a second A/V processor 220. Each of the plurality of A/V processors 200 may comprise any suitable A/V processor such as, for example, a conventional A/V processor as found in conventional STBs. The anticipatory processing system 100 further preferably includes a controller 230 that controls at least the first A/V processor 210 and the second A/V processor 220 and preferably, but not necessarily, additional A/V processors of the plurality of A/V processors 200 or all the A/V processors 200.

The plurality of A/V processors 200 preferably receive the program transmissions from the headend 20 and/or the plurality of cameras 25 of the broadcast source via the satellite 30. Program transmissions transmitted by the cameras 25 may preferably include a panoramic view of an object or a scene. Preferably, each of the plurality of cameras 25 provides a viewing range which is a subset of the panoramic view. The panoramic view may depend on an area to be included in the view, for example the panoramic view may include an approximately 360-degree view.

Regardless of the source of the program transmissions received at the plurality of A/V processors 200, the program transmissions may preferably be inputted to the anticipatory processing system 100, for example, via an antenna connector 240 and coaxial cables 250 connected to the connector 240 and to the plurality of A/V processors 200. The transmissions received by the plurality of A/V processors 200 may preferably include audio and/or video content.

Preferably, the audio and/or video content may include an encoded data stream. The encoded data stream preferably includes an encoded video stream such as an MPEG data stream (MPEG—Motion Picture Experts Group). The MPEG data stream may include an MPEG-2 data stream and/or an MPEG-4 data stream. Each of the plurality of A/V processors 200 preferably includes or is associated with a decoder for decoding the encoded data stream. By way of example, all decoders of the plurality of A/V processors 200 may be MPEG decoders comprised in an MPEG unit 260 that is comprised in the plurality of A/V processors 200. If the MPEG data stream includes an MPEG-2 data stream, each MPEG decoder preferably includes an MPEG-2 decoder. If the MPEG data stream includes an MPEG-4 data stream, each MPEG decoder preferably includes an MPEG4 decoder. It is appreciated that the MPEG unit 260 and the plurality of A/V processors 200 may be comprised in a single element.

The MPEG unit 260 preferably performs MPEG decoding on content received from any of the plurality of A/V processors 200 under control of the controller 230. The MPEG unit 260 is also preferably operative to output clear content to a display unit 270 that is operative to display audio and/or video content, and/or to a content storage unit 280. The content storage unit 280 is preferably operative to store at least some of the audio and/or video content. The content storage unit 280 may preferably include an internal memory such as a solid-state memory or a hard disk (HD).

In a case where the transmissions received by the plurality of A/V processors 200 include analog audio and/or video content, the plurality of A/V processors 200, or some of them, may preferably include or operate as a plurality of tuners, the controller 230 preferably controls the plurality of tuners, and the content storage unit 280 may include, for example, a video cassette recorder (VCR). In such a case, the MPEG unit 260 may be optional. It is appreciated that each of the plurality of tuners may comprise any suitable tuner such as, for example, a tuner comprising conventional analog tuning and decoding circuitry as found in conventional analog STBs.

The controller 230 may preferably include a special-effects generator 290 for locally producing special effects. Preferably, the controller 230 is operatively associated with the following elements: the content storage unit 280; a processor 300; and a modem 310. The processor 300 may preferably include an on-screen display (OSD) unit. It is appreciated that the controller 230 and the processor 300 may be combined in a single processing element (not shown) that may be embodied in a single integrated circuit.

The processor 300 is preferably operatively associated with the following units: the plurality of A/V processors 200; the content storage unit 280; the modem 310; an input/output (I/O) unit 320; and a security element interface 330.

It is appreciated that the controller 230 may also preferably be operatively associated with the I/O unit 320 and the security element interface 330, for example via the processor 300.

The I/O unit 320 preferably receives commands and other inputs from the RC 150 employed by the user 140. The security element interface 330 preferably provides an interface to a security element. The security element may preferably include a smart card 340 in which case the security element interface 330 is a smart card reader/writer.

In a case where the anticipatory processing system 100 is comprised in the STB 80, the display unit 270 may preferably include the display 90, the smart card 340 may be the smart card 130, and the security element interface 330 may include the slot 120. It is however appreciated that the anticipatory processing system 100, or at least the plurality of A/V processors 200 and the controller 230, may alternatively be comprised in a cellular telephone (not shown). In such a case, the display unit 270 may be a display of the cellular telephone (not shown).

In a first preferred mode of operation, the controller 230 generates a prediction of an event determining program material to be displayed, and instructs an A/V processor controlled thereby, for example the A/V processor 210, to prepare a digital stream for use in response to the prediction of the event. The controller 230 may also preferably control the A/V processor 210 for preparing A/V information associated with the program material for display in association with the digital stream in response to the prediction of the event. The digital stream is preferably associated with a channel, and throughout the specification and claims the terms “digital stream” and “channel” or “digital channel” are interchangeably used. The digital channel may preferably be a regular channel or a virtual channel.

It is noted that the term “analog channel” is used throughout the specification and claims for any type of analog channels, in particular analog television channels.

Preferably, the A/V processor 210 prepares the digital stream for use by performing at least one of the following: preparing the digital stream for rendering; preparing the digital stream for storage; and preparing the digital stream for distribution via another communication network (not shown).

The term “render” is used, in all its grammatical forms, throughout the present specification and claims to refer to any appropriate mechanism or method of making content palpable to one or more of the senses. In particular and without limiting the generality of the foregoing, “render” refers not only to display of video content but also to playback of audio content.

After the digital stream is prepared for use, the A/V processor 210, operating under control of the controller 230, preferably uses the digital stream if the event occurs. For example, if the event occurs, the A/V processor 210 may display the A/V information associated with the program material in association with the digital stream on the display unit 270. Alternatively, the A/V processor 210 may provide the A/V information associated with the program material to the content storage unit 280 for storage therein, or distribute the A/V information associated with the program material. It is appreciated that the controller 230 may instruct the A/V processor 210 to use the digital stream at a time after termination of preparation of the digital stream for use. The time after termination of preparation of the digital stream for use may be, for example, immediately after termination of preparation of the digital stream for use or a later time.

The event preferably includes at least one of the following: user input; an indication of a commercial break; an instruction from the headend 20 or the broadcast source; an instruction from a computer program predicting user behavior based on a user profile; an alert associated with a current display; and at least one message from a broadcaster or a service provider. The program material preferably includes a commercial or a segment of a television program. It is appreciated that if the television program is an interactive television program, the segment of the television program may include any segment of the program, such as multimedia data accompanying the program, a broadcast segment of the program, etc.

Preferably, the A/V processor 210 prepares the A/V information for display in association with the digital stream by performing at least one of the following: preparing the A/V information for display over a channel associated with the digital stream; preparing the A/V information for display together with the digital stream in a picture-in-picture (PIP) mode; and preparing the A/V information for display together with the digital stream in a side-by-side mode.

A second preferred mode of operation refers to the above-mentioned case in which the transmissions received by the plurality of A/V processors 200 include analog audio and/or video content. Preferably, in the second preferred mode of operation the controller 230 generates a prediction of an event determining program material to be displayed, and a tuner of the plurality of tuners, being controlled by the controller 230, prepares an analog channel, such as an analog television channel, for use in response to the prediction of the event. It is appreciated that the tuner may also preferably prepare A/V information associated with the program material for display over the analog channel in response to the prediction of the event.

If the event occurs, the tuner preferably uses the analog channel, for example by rendering the analog channel over the display unit 270, or by recording the A/V information and/or the program material in the VCR.

In a third preferred mode of operation, the controller 230, upon the first A/V processor 210 rendering or preparing for rendering a first digital stream, instructs the second A/V processor 220 to prepare a second digital stream for rendering based, at least in part, on predicted input. The second A/V processor 220, operating under control of the controller 230, preferably renders the second digital stream after termination of preparation of the second digital stream for rendering if the predicted input is actually inputted.

Preferably, the controller 230 generates the predicted input based upon at least one of the following: user input; an indication of rendering or preparation for rendering of the first digital stream; an indication of a commercial break; an instruction from the headend 20 or the broadcast source; an instruction from a computer program predicting user behavior based on a user profile; an alert associated with a current display; and at least one message indicating current or scheduled occurrence of an event.

Preferably, the controller 230 includes a stream selector (not shown) for choosing any one of the first digital stream and the second digital stream from at least one of the following: a broadcast multiplex; and a plurality of digital content items stored in a memory such as the content storage unit 280. When the first digital stream is chosen, the A/V processor 210 preferably processes the first digital stream and outputs audio content and/or video content to the display unit 270 for display. The second digital stream, being prepared by the A/V processor 220 for rendering based on the predicted input, may, for example, be provided by the A/V processor 220 to the display unit 270 for display in a picture-in-picture (PIP) mode together with the audio and/or video content outputted by the A/V processor 210, or to the content storage unit 280 for storage therein. If the second digital stream is stored in the content storage unit 280, the controller 230 may preferably retrieve the second digital stream for display on the display unit 270 at a suitable time.

In a case where the controller 230 generates the predicted input based upon user input, the user input may preferably include user channel changes performed by the user 140. The user channel changes may, for example, include a channel change in a first direction in which case the predicted input may be one of the following: a channel change in the first direction; and a channel change in a direction opposite to the first direction. The first direction may, for example, include exactly one of the following: an upward direction; and a downward direction. It is appreciated that the user channel changes may include changes between exactly one of the following: virtual channels; and regular channels.

Channel changes may also preferably be generated as a result of an instruction from the headend 20 or the broadcast source. The controller 230 may thus generate the predicted input based upon channel changes suggested or implemented by the headend 20 or the broadcast source and/or a combination of user channel changes and channel changes suggested or implemented by the headend 20 or the broadcast source.

The predicted input may also be used by the controller 230 to determine at least one favorite channel, for example, by determining a channel to which the user 140 returns many times during channel changing.

Preferably, the controller 230 or the display apparatus 110 may track a discrete object based, at least in part, on information concerning a path of the object. The discrete object may include, for example, a person appearing in a program transmission, such as an actor, a player, or an audience member. The controller 230 or the display apparatus 110 preferably tracks the person only upon receipt of an indication of at least one of the following: knowledge of the person; and permission of the person to be tracked.

Preferably, the processor 300, or alternatively the controller 230, receives the indication from at least one of the following: directly from the person; the broadcast source; and the headend 20. In a case where the indication is received from the broadcast source or the headend 20, the person may signal the permission to be tracked to the broadcast source or the headend 20, and the broadcast source or the headend 20 preferably generates the indication from an authorization list of parties with permission to track the person that is provided by the person.

Preferably, after permission to track the discrete object is established, the controller 230 or the display apparatus 110 may preferably track the discrete object by processing images received, for example, from the plurality of cameras 25 that together provide a panoramic view of the object, wherein each camera of the plurality of cameras 25 provides a viewing range which is a subset of the panoramic view. It is appreciated that processing of the images received from the plurality of cameras 25 may preferably provide the required information concerning the path of the object.

When the predicted input is generated based upon user input, current and previous operations of the user 140 may influence preparation of digital streams for rendering and preparation of A/V information for future display so that if the user 140 indeed follows a predicted behavior pattern that is based upon the user's current and previous operations, display events such as A/V insertion, advertisement display and channel changes may be carried out smoothly thereby improving the viewing experience of the user 140.

For example, when the user 140 watches program transmissions displayed on the display 90 and/or uses interactive applications associated with the program transmissions, the processor 300 preferably tracks user inputs of the user 140. It is however appreciated that since, as mentioned above, the processor 300 and the controller 230 may be combined in a single processing element, the controller 230 may alternatively perform any processing task of the processor 300, including tracking of the user inputs.

Tracking of the user inputs by the processor 300 preferably results, at a point in time, in determination of a user input that was entered until the point in time. Such user input is referred to throughout the specification and claims as “previous user input”. The previous user input may include, for example, previous user channel changes, such as channel changes in a first direction.

Preferably, the previous user input is, at least partially, used for predicting a future input. For example, if the previous user input includes channel changes in a first direction, a predicted input may include a further channel change in the first direction, where the first direction is either an upwards direction or a downwards direction. Alternatively, if the previous user input includes channel changes in the first direction and a user behavior is detected in which the user 140 changes channels back and forth, the predicted input may include a channel change in a direction opposite to the first direction. In any case, it is noted that predicted input may be computed from information gathered on previous user input.

Once predicted user input is determined, then, while current images of a current channel accessed via one A/V processor, such as the A/V processor 210, are being displayed, another A/V processor, such as the A/V processor 220, may preferably begin processing images of a predicted next channel. When a channel change from the current channel to the predicted next channel occurs, the images of the predicted next channel may preferably be displayed much faster than in a conventional channel change in which the anticipatory processing system 100 is not used, or even seamlessly. This is because the processing of the images of the predicted next channel has already been carried out partially or even entirely before actual implementation of the channel change. The channel change is therefore executed smoothly and with a reduced delay when compared to a delay experienced in a conventional channel change that does not involve the anticipatory processing system 100.

It is appreciated that the controller 230 selects and controls the A/V processor 210 for accessing the current images and the A/V processor 220 for processing the images of the predicted next channel.

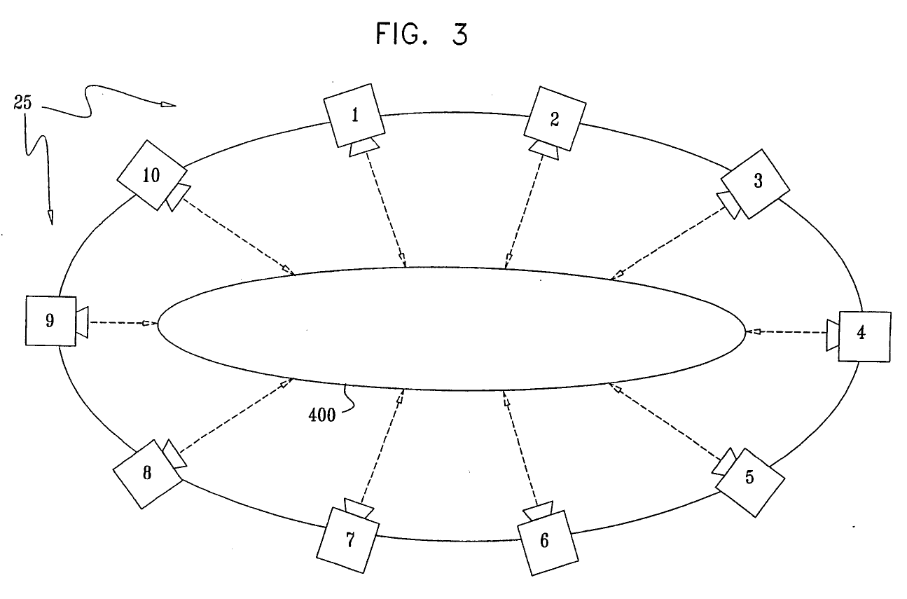

Smoothing of channel changes may be useful in many applications. FIG. 3 illustrates an example of the interactive sports game application mentioned above with reference to FIG. 1 in which smooth channel changes may be used to enhance viewing experience of the user 140. The example depicted in FIG. 3 refers to the sports game being played in a playing field 400 that is broadcast to the user 140 and displayed on the display 90. The player 160 depicted in FIG. 1 is a player in the sports game.

Preferably, a plurality of cameras, for example the cameras 25 are arranged around the playing field 400, for example, equidistantly from each other. The cameras 25 are preferably arranged such that each of the cameras 25 takes video images at a different viewing angle of the game and possible paths that the user 140 can take from each camera being viewed to another are predetermined.

It is appreciated that a distance between any two cameras 25 may be determined by various methods that are well known in the art. For example, a tape measure may be used to measure the distance between any two cameras 25. Alternatively, conventional electronic distance measurement devices that use sound waves or lasers may be used for computing the distance between any two cameras 25.

In the example depicted in FIG. 3, there are ten cameras 25 in total, and they are numbered from one to ten. Each camera outputs video and/or audio of the game at its specific viewing angle over a different channel. One channel, for example a channel associated with camera 1, may be a regular channel and channels associated with cameras 2-9 may, for example, be virtual channels. It is assumed that a typical behavior of the user 140 while watching the game includes frequent channel changes in order to view the game from different angles.

If, for example, the user 140 watches the game via camera 8 at a certain point in time, selection of a channel associated with camera 8 may preferably be registered as a previous user input. If, as mentioned above, possible paths that the user 140 can take are predetermined, then a prediction of future user input may, for example, be channel changing to watch the game either via camera 7 or via camera 9. It is appreciated that in order to perform such a channel changing, the user 140 may, for example, press either a conventional “LEFT” arrow key on the RC 150 or a conventional “RIGHT” arrow key on the RC 150.

Upon generation of predicted user input, the anticipatory processing system 100 may preferably begin processing, and if necessary storing, images obtained via camera 7 and camera 9 while images obtained via camera 8 are being displayed. If, for example, the A/V processor 210 is used for obtaining images captured by camera 8, the controller 230 may preferably instruct the A/V processor 220 to tune to a channel associated with camera 7 and an additional one of the A/V processors 200 to tune to a channel associated with camera 9. If additional A/V processors 200 are available in the anticipatory processing system 100, processing of channels associated with additional cameras, such as camera 6 and camera 10 may also be initiated while images obtained by camera 8 are being displayed.

Alternatively or additionally, background processing of images from more than one predicted path may be interleaved on a single A/V processor. For example, upon the A/V processor 210 accessing images being displayed, the A/V processor 220 may perform preparatory processing on a number of channels to which the user may tune. In such a case, the A/V processor 220 may preferably process, in parallel or in succession, different digital streams associated with different channels, and possibly even store information obtained from the different digital streams.

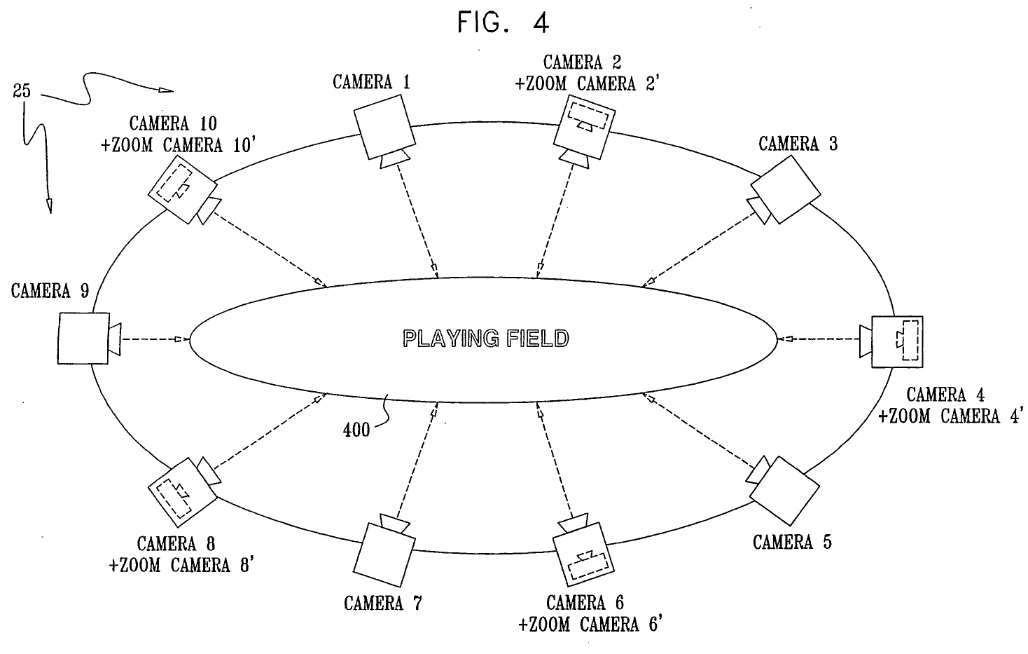

Each of the cameras 25 may additionally or alternatively be associated with virtual channels that refer to special effects of the cameras 25. One such special effect may include zooming as illustrated, for example, in FIG. 4 which is a simplified partly pictorial partly block diagram illustration of another preferred implementation of the game application depicted in FIG. 3.

Referring additionally to FIG. 4, the user 140 may have an option of zooming through camera 8′, for example, by pressing a toggle zoom-enabled/zoom-disabled key (not shown) in the RC 150, where the symbol ‘′’ refers to a zoom of a normal view of a camera associated therewith. A zoom-enabled option for zooming-in or zooming-out may preferably be associated with a virtual channel associated with camera 8′. When viewing the game from camera 8′, predicted user input may, for example, be channel changing to watch the game via one of the following: camera 8; camera 6′; and camera 10′. When viewing the game from camera 8 with the option of zoom-enabled, predicted user input may, for example, be channel changing to watch the game via one of the following: camera 7; camera 9; and camera 8′.

The option of zooming may alternatively be provided by several rings of cameras (not shown) at different radial distances from a center of the playing field 400. A camera selected from an inner ring may correspond to a zoom-in selection, and a camera selected from an outer ring may correspond to a zoom-out selection. Each camera in each ring may, for example, be associated with a different virtual channel.

Other special effects may be created by deliberately having cameras that are mobile, cameras with slow motion options, and so on. It is appreciated that each camera with a special effect may preferably be associated with a virtual channel that the user 140 may tune to smoothly using the anticipatory processing system 100 which predicts user selection for viewing the game via the camera with the special effect. Preferably, prediction of selection of mobile cameras by the anticipatory processing system 100 is based upon proximity of the mobile cameras to stationary cameras.

Preferably, metadata that signals points in time at which a smooth transition between channels is possible may be generated at the headend 20 and transmitted to the STB 80. The term “metadata” is used throughout the specification and claims to include information descriptive of or otherwise referring to a digital content stream. The information referring to the digital content stream may include, for example, pointers and indexing information.

It is appreciated that different possible paths from a specific camera may be assigned different levels of priority. For example, a path from camera 8 to camera 9 may have a higher processing priority than a path from camera 8 to camera 7 if the behavior of the user 140 is found to include clockwise scanning of the playing field 400.

When combined with a continuous moving-camera view, regular discrete views, such as discrete views arranged in a picture-in-picture (PIP) form may also be available while scanning the playing field 400. Preferably, one option is for the discrete views displayed at any instant to depend on a particular location currently being scanned via cameras taking images of the particular location. For example, scanning the playing field 400 through camera 1 followed by camera 2 may cause, in addition to the continuous moving camera view, a tickertape effect of selectable thumbnail discrete images to move across the bottom of the display 90.

In order to achieve such an effect, the anticipatory processing system 100 preferably receives information regarding which discrete pictures are associated with each camera and how to access them, the location on a screen of the display 90 for displaying each discrete picture when the current view is being shown, and how to shift the location of each discrete picture for each subsequent camera view displayed. Alternatively or additionally, the anticipatory processing system 100 may automatically exclusively associate each discrete picture with a cell in an array of locations at which to display the picture. A determination of the array may, for example, be stored in the content storage unit 280 of the anticipatory processing system 100, or stored in the STB 80 and accessed by the anticipatory processing system 100. It is appreciated that a location associated with each cell of the array may be predefined or dynamically updated in response to receipt of cell location data from the headend 20.

When a camera view changes, or when the number of discrete pictures to be displayed exceeds the number of location cells with which to associate them, or simply after a period of time, the excess previously received discrete pictures are removed and at least some of the remaining discrete pictures may be associated with a different cell either according to a predefined algorithm or as instructed by the headend 20. For example, if a tickertape effect is to be achieved and the user 140 is scanning cameras from left to right, each time a subsequent new discrete picture is to be displayed all previously received discrete pictures may be associated with a cell to the left of their previously associated cell, or removed if associated with the leftmost cell, and the new discrete picture may be associated with the rightmost cell.

Preferably, predetermined data associated with the cameras 25, such as data identifying the predetermined paths that the user 140 can tale from each camera being viewed to another, is broadcast in association with video images taken by the cameras 25. It is appreciated that the data identifying the predetermined paths that the user 140 can take from each camera being viewed to another may include path tables (not shown) for all the cameras 25 or for each of the cameras 25 individually.

Alternatively, the predetermined data, or a portion thereof, may be broadcast prior to broadcast of images taken by the cameras 25 and stored in the content storage unit 280 for use during the broadcast of images taken by the cameras 25. Further alternatively, the predetermined data may be transmitted after the broadcast of the images taken by the cameras 25 if the images taken by the cameras 25 are stored for later use. It is appreciated that the predetermined data may be transmitted via a medium different than a medium used for broadcasting the images taken by the cameras 25.

In addition to the data identifying the predetermined paths that the user 140 can take from each camera being viewed to another, the predetermined data may preferably include at least some of the following: image synchronization information; data related to special effects; data related to association of discrete regular views with cameras; data related to changes in distance between cameras; and conditional access information.

The image synchronization information preferably includes information used for synchronizing transmission of images between the cameras 25. The image synchronization information may alternatively or additionally include a time stamp that may be transmitted with each image from each associated camera. In such a case, the STB 80 may preferably be operative to decide when to switch between the cameras 25 and which images to display from each camera based on the time stamp.

The data related to special effects may preferably be transmitted to inform the STB 80 how to produce the special effects. For example, the data related to special effects may include at least one of the following: an indication of a: rate of image production for each camera; an instruction to take an image with an earlier timestamp if scanning via the “LEFT” arrow key in the RC 150 is performed; an instruction to alternate between a regular view and a zoomed view when switching between cameras; and an instruction to activate sound effects when switching to a specific camera. The sound effects may include, for example, a zoom sound effect or an indication of a required sound effect that is stored in the content storage unit 280.

The data related to association of regular discrete views with cameras is preferably used to indicate dependence of discrete regular views on images displayed by a current camera. For example, display of a regular discrete view may depend on a main image taken by the current camera in which the regular discrete view is displayed in a PIP form.

The data related to changes in distance between cameras is preferably used in a case where a distance between two of the cameras 25 varies. For example, if one of the cameras 25 is mobile, the data related to changes in distance between cameras may include a difference in positional values between the mobile camera and a static camera and a direction of travel of the mobile camera towards or away from the static camera. It is appreciated that the data related to changes in distance between cameras may be transmitted to the STB 80, or the STB 80 may generate such data from previous values if such values are transmitted to the STB 80.

The conditional access information may preferably be used to authorize the user 140 to manipulate camera views between the cameras 25.

It is appreciated that alternative patterns of arrangements of the cameras 25 may be employed depending on an environment in which the cameras 25 are placed. For example, if the cameras 25 are placed in a theatre, the cameras 25 may be arranged as a wall of cameras in which each camera is focused on a section of a stage during, for example, a live theatre production that is broadcast. In such a case, the user may employ the anticipatory processing system 100 in his STB 80 to individually change a view of the stage, zoom in on a particular actor, and perform other operations simulating his actually being in the theatre.

The anticipatory processing system 100 may also preferably be used to reduce zapping time during regular digital channel surfing in a broadcast system that is not interactive. Referring to a first example in which the user 140 zaps from channel 5 to channel 10, the system 100 may preferably start background processing of images, audio, and data associated with the following: an anticipated next channel 11 associated with the “RIGHT” arrow key on the RC 150; an anticipated previous channel 9 associated with the “LEFT” arrow key on the RC 150; and a toggle channel 5 associated with another key on the RC 150.

It is appreciated that priorities for anticipating a next choice of the user 140 may preferably be established based on the zapping behavior of the user 140. For example, if the user 140 presses the “RIGHT” key a few times in succession, the system 100 may provide greater priority to processing the next channel 11 than to processing the previous channel 9.

In a second example, if the user 140 has just viewed the channels 186, 187, 188 by repeatedly pressing the “NEXT” key on the RC 150, it is expected that for a next channel selection the likelihood of the user 140 selecting channel 189 is higher than the likelihood of the user 140 selecting channel 187, and the likelihood of the user 140 selecting channel 187 is higher than the likelihood of the user 140 selecting channel 15. It is appreciated that paths to channels 189 and 187 may thus have a higher priority level than a path to channel 15 and A/V processors may be assigned to channels 189, 187 and 15 for processing according to the appropriate priority levels.

In a third example, if the user 140 uses a toggle key on the RC 150 to jump backwards and forwards between, for example, the channels 215 and 420, the anticipatory processing system 100 may predict that the next channel change may be to channel 215, and to a lesser extent to channels 421 or 419.

In a case where a channel change requires the pressing of more than a single key, such as two keys, then, from a time when the first key is pressed, the anticipatory processing system 100 may preferably try to assign priorities to future possible choices and assign A/V processors accordingly. For example, previous behavior may indicate that when the user 140 presses an initial ‘2’ he usually follows this by pressing a second ‘2’and then a ‘3’ (that is, channel 223), though on fewer occasions the second key would be ‘1’ followed by a ‘5’ (that is, channel 215).

It is appreciated that there may be surfing patterns that the anticipatory processing system 100 may learn in both interactive and non-interactive broadcast systems. For example, the anticipatory processing system 100 may learn that once the user 140 switches, for example, to a news channel, he is likely to switch to another news channel. Similarly, the anticipatory processing system 100 may learn other preferences of the user 140, such as preferences to view movies on movie channels.

In addition to normal user surfing behavior that the anticipatory processing system 100 may learn, the anticipatory processing system 100 may also predict user surfing behavior in a case where an alert or a message displayed on a current tuned channel encourage the user 140 to switch to another channel. The alert or the message may be displayed either in response to a previous request by the user 140 or a previous indication of interest by the user 140, or according to a determination performed at the headend 20. For example, an advertisement displayed on a current tuned channel may inform the user 140 that a product is about to be offered for sale on a shopping channel, or that a movie is about to start on a movie channel. In such a case, the headend 20 may preferably broadcast information comprising an alert relating to the channel being promoted, such as an ID of the channel being promoted, details of a product/service being promoted, etc. The anticipatory processing system 100 may optionally consult a user profile of the user 140 that may be stored, for example in the content storage unit 280, to ascertain that the product/service is indeed of interest to the user 140. It is appreciated that the anticipatory processing system 100 may implement a channel change to tune to the channel being promoted either in response to a selection by the user 140 or alternatively automatically.

The user profile of the user 140 is preferably based upon viewing information gathered within a time period and the anticipatory processing system 100 may preferably use such information for prediction of user input. For example, the user profile of the user 140 may show that the user 140 always watches the news at 5 PM on channel 22, but prefers to watch the fashion channel 20 at all other times. Therefore, when the user 140 presses an initial key ‘2’ just before 5 PM, or perhaps even if the user 140 does not press any key, the anticipatory processing system 100 may give a priority to a prediction that the next key will be ‘2’, but at other times a priority to the channel 20 that is obtained by pressing the key ‘0’ as the second key.

Alternatively or additionally, if the user profile of the user 140 shows that the user 140 often watches a specific channel, then even if the user 140 is currently watching another channel and has not indicated any intention to change channels, the anticipatory processing system 100 may predict a change to the specific channel which is preferably referred to as a favorite channel.

Further alternatively or additionally, if the user profile of the user 140 shows that the user 140 tends to switch channels during certain events, for example, when a program currently being watched is interrupted by advertisements, the anticipatory processing system 100 may predict a channel change before the event occurs provided the anticipatory processing system 100 receives information that the event is about to occur.

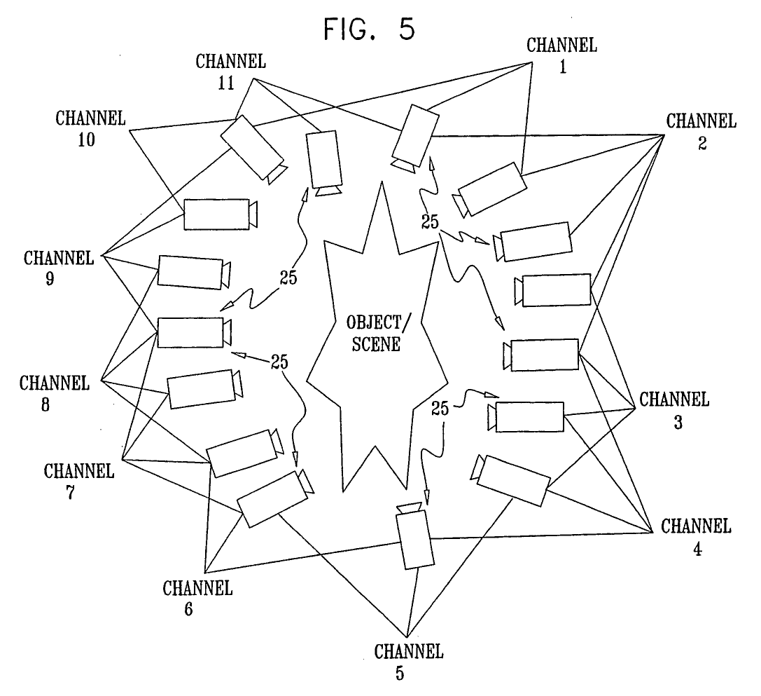

It is appreciated that anticipatory processing may be used in combination with preprocessing at the headend 20. For example, the headend 20 may preprocess images from some of the cameras 25 to produce 3-Dimensional (3D) images from different viewing angles, and anticipatory processing may be employed at the STB 80 to select a channel associated with a specific view of the 3D images. Production of 3D images from different viewing angles is well known in the art; one particular non-limiting example is described in the above-mentioned U.S. Pat. No. 5,850,352 to Moezzi et al, the disclosure of which is hereby incorporated herein by reference. An arrangement of the cameras 25 to enable control of a viewing angle of a 3D image in a 3D application is depicted in FIG. 5.

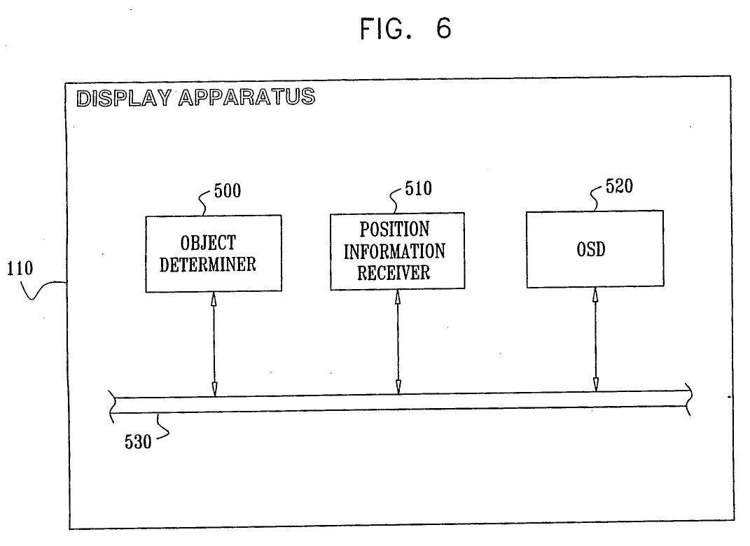

Reference is now additionally made to FIG. 6 which is a simplified block diagram illustration of a preferred implementation of the display apparatus 110 in the interactive broadcast system 10 of FIG. 1.

The display apparatus 110 preferably includes the following elements: an object determiner 500; a position information receiver 510; and an OSD unit 520. The object determiner 500, the position information receiver 510 and the OSD unit 520 may communicate with each other, as well as with other elements, for example via a communication bus 530 or via other appropriate communication interfaces (not shown) that may be comprised in the display apparatus 110 or associated therewith.

It is appreciated that the display apparatus 110 may be used in the STB 80 in a configuration of the anticipatory processing system 100 of FIG. 2 in which the display apparatus 110 replaces the controller 230 or the processor 300, or is embodied in the controller 230 or the processor 300. In such a case, the object determiner 500, the position information receiver 510 and the OSD unit 520 may each preferably be operatively associated with each of the following elements of the system 100, for example via the communication bus 530: the plurality of A/V processors 200; the MPEG unit 260; the content storage unit 280; the modem 310; the I/O unit 320; and the security element interface 330.

In order for the display apparatus 110 to enable marling of an object of interest on the display 90, the STB 80 is preferably associated at least with the user 140 who is authorized to view the object of interest and may receive information via a telephone message. If the user 140 is authorized to view the object of interest, the display apparatus 110 becomes functional to track and/or mark the object of interest. In such a case, the object determiner 500 preferably determines the object of interest based, at least in part, on user input, and the position information receiver 510 preferably receives, from a source remote to the display apparatus 110 such as the headend 20 or the broadcast source, information defining a position of the object of interest within a displayed picture. Then, the OSD unit 520 preferably displays a visible indicator at a display position on the display 90, the display position being based, at least in part, on the position of the object of interest. It is appreciated that the information is preferably sent from the headend 20 or the broadcast source and is typically addressed to at least one particular viewer, such as the user 140.

The object of interest is preferably operatively associated with identification (ID). Preferably, the object of interest includes a person, such as an actor, a player or an audience member.

It is appreciated that the position information receiver 510 preferably receives the information from the source remote to the display apparatus 110 only upon generation of an indication of at least one of the following: knowledge of the person; and permission of the person to be tracked. The indication is preferably generated at the source from an authorization list of parties with permission to track the person that is provided by the person. The position information receiver 510 may receive the permission to be tracked from the person either via the source or directly from the person.

The operation of the display apparatus 110 in the interactive broadcast system 10 is now briefly described.

Typically, views broadcast by a plurality of cameras, such as the cameras 25, may contain elements that are of individual interest to specific viewers. For example, the user 140 may be interested in tracking a particular player in a football game, or a specific actress in a theatre production. The user 140 may also be interested in tracking his/her friends or family in an audience that appears in a scene typically with acquiesce of a person being tracked. Methods and devices for tracking an individual object as it moves within an area scanned by various cameras, and changing camera views in accordance with the object's movements are known in the art; one particular non-limiting example is described in the above-mentioned U.S. Pat. No. 6,359,647 B1 to Sengupta, the disclosure of which is hereby incorporated herein by reference. However, as mentioned above, changing camera views is typically associated with a noticeable delay. The display apparatus 110 may preferably be used to allow each viewer to track and mark any selected object in a scene with a reduced delay.

It is appreciated that MPEG-2, for example, supports a feature that allows cropping and scaling of video images, that is, for example, selecting a portion of a video image and displaying the portion of the video image in full-screen. Such a feature may preferably be utilized in tracking a person in a scene by broadcasting a limited number of very high-quality large-scale video sequences, and additional associated metadata describing which crop and scale factors to apply to an image in order to focus on particular players and other objects. This feature typically saves considerably on video bandwidth, while still allowing highly personalized focus.

Referring for example to the sports game application mentioned above ith reference to FIGS. 1 and 3, each frame or group of frames that is sent by each of the cameras 25 may preferably be associated with a range of location values. The location values may, for example, include coordinates encompassing a length, a breadth and a depth covered by each camera. The coordinates may, for example, be a factor of the focus of each camera.

Each player in the sports game may, for example, wear a device that returns position information. For example, the device may include a reflector that enables triangulation by laser to determine position of the player. Alternatively, if the field-of-view of each camera is sufficiently large, the conventional Global Positioning System (GPS) may be used to determine position of the player wearing suitable means responsive to the GPS. Further alternatively, the position of the player may be determined by an image processor (not shown) associated with each camera. Using any of the above means and methods for determining position of the player, tracking information of each player may preferably be obtained at each instant and transmitted to the headend 20.

The headend 20 preferably compares each player's tracking information with location coordinates produced by frames of appropriate cameras at the same instant. Then, the headend 20 preferably translates the tracking information for each player into a series of ID numbers of those of the cameras 25 producing frames in which the players appear. The ID numbers of those of the cameras 25 producing frames in which the players appear are referred to herein after as “camera IDs”.

Preferably, the headend 20 broadcasts the camera IDs together with associated tracking information of the players or location details of the players and IDs of cameras that are currently scanning the players' current location. Alternatively or additionally, individual tracking information of each player may be broadcast together with coordinates covered by each camera.

On receipt of broadcasts from the headend 20, the object determiner 500 preferably determines a specific player of interest, such as the player 160, based, at least in part, on input of the user 140. The position information receiver 510 receives the tracking information that defines a position of the player 160 within a displayed picture. The OSD unit 520 may then compare the tracking information of the player 160, or receive comparison results from the processor 300, in order to decide which camera view to show if the user 140 requests to track the player 160. The OSD unit 520 may also preferably display, if the user 140 requests to track the player 160, the visible indicator 170 at a display position on the display unit 90, where the display position is based, at least in part, on the position of the player 160.

For tracking an audience member at the sports game, the audience member may transmit his location to the STB 80. For example, the audience member may initiate a telephone call or a communication session via a communication device such as a Personal Digital Assistant (PDA) (not shown) with the headend 20 and transmit location information, personal ID information, and information identifying the STB 80. The headend 20 may preferably address such information to the STB 80, for example by over-the-air broadcast, via telephone, or via the Internet.

Alternatively, the audience member may communicate relevant location information and personal ID information directly to the STB 80. The STB 80 may then transmit the information received from the audience member to the headend 20, for example, via a conventional callback procedure, and the headend 20 may transmit back to the STB 80 a required camera ID and associated information.

Alternatively, the STB 80 may receive location coordinates together with image frames from an individual one of the cameras 25 and then process location information received directly from the audience member to obtain appropriate camera IDs. It is appreciated that any audience member wishing to transmit to the STB 80 may be required to provide means of proving authorization, such as a password/PIN. Preferably, the identity of the audience member transmitting to the STB 80 must be established before tracking of the audience member is enabled.

Alternatively, providing an ID of the STB 80 may be sufficient for proving authorization if a telephone number of a device making a call to the STB 80 is paired in advance with the STB 80. For example, a caller's telephone number may be used as an ID for establishing an authorization for tracking purposes. Alternatively or additionally, the STB 80 may include or be associated with a conventional caller ID device (not shown) that shows an ID of a caller, and the user 140 may identify the audience member according to his/her ID displayed by the caller ID device. Further alternatively or additionally, the user 140 may have a predefined list of people that can call the STB 80 of the user 140.

It is appreciated that the headend 20 may transmit the camera IDs of all the cameras 25 or only the “best” camera IDs according to predefined criteria. The predefined criteria may be, for example, proximity of a player to a camera, proximity of the player to the center of a frame of the camera, and so on. Alternatively or additionally, the STB 80 may select the best views from received camera IDs. For example, the STB 80 may select a camera ID of a camera that is closest to a camera whose view the user 140 is currently viewing. This may particularly be useful in applications such as the game application of FIG. 3.

In the application of FIG. 3, if, for example, camera 2 and camera 5 both provide good views of a specific player, and the user 140 is currently viewing the game via camera 3, then the STB 80 may preferably select a frame associated with the camera ID of camera 2 as a view to offer the user 140 because camera 2 is in closer proximity to camera 3 than camera 5.

In a case where an effect of zooming is enabled as mentioned above with reference to FIG. 4, if the best view of a specific player is via camera 2′, the user 140 may preferably be offered camera 2 and then if the user 140 wants to take a closer look, he can select camera 2′. The display apparatus 110 may be configured to give the user 140 the best regular view first, and then allow the user 140 to decide whether or not to zoom in. Alternatively, the display apparatus 110 may be configured to give the user 140 a corresponding zoom view when such a view is the best view available.

As an alternative to the headend 20 processing location information from the cameras 25 and tracking devices, such information may be broadcast unprocessed to the STB 80 where it may be translated into appropriate camera views.

Preferably, the user 140 may select camera views that display the specific player or the audience member, or request that camera views change automatically in order to track the specific player or the audience member. In response to a “TRACK” selection entered by the user 140, for example by pressing a “TRACK” key (not shown) on the RC 150, the display apparatus 110 may preferably automatically show the best view of the specific player or the audience member from an instant of selection and on. The best view may, for example, be obtained by switching camera views automatically based on movements of the specific player or the audience member. Alternatively, an available view from which the player or the audience member may be seen may be marked for example by placing an identifier, such as a name or a flashing dot, next to a thumbnail view, and the available view may then be selected by selecting the identifier.

Additionally, or as an alternative to having the user 140 select a “TRACK” option, a list of players that may be viewed via each camera may be associated, for example via PIP, with distinct regular discrete views from the camera.

The player or audience member may be marked by superimposing over the view from which the player or the audience member may be seen a frame mark, such as a circle, around an actual area on the display 90 where the player or audience member appears. The visible indicator 170 depicted in FIG. 1 is an example, which is not to be considered as limiting, of such a frame mark. The frame mark may preferably be transmitted as a transparent OSD that is to be overlaid over an area of the display 90 where the player or audience member appears.

The frame mark may especially be useful in a case where the user 140 selects an option of zooming as described above. It is appreciated that marking of the player or audience member as mentioned above may also be useful in a case where only a single camera is used. Given a position, or approximate area, of the player or audience member on the display 90 and coordinates covered by a respective camera view, the STB 80 may preferably position an OSD appropriately to surround that area.

It is appreciated that by using cropping and scaling of video images as mentioned above the headend 20 may keep track of the player or the audience member and enable display of an image of the player or the audience member in a reasonably fixed position on the display 90. OSD position may therefore be predefined leaving the headend 20 responsible for generating crop/scale factors accordingly.

During tracking of the player or the audience member, the player or the audience member may move to exit a first camera view taken by a first one of the cameras 25 and enter a second camera view taken by a second one of the cameras 25. In such a case, detection of object exit from one camera's field-of-view and entry into another camera's field-of-view as is well known in the art may be used in association with anticipatory processing as mentioned above for anticipating into which camera view the player or the audience member will enter next. It is appreciated that the second one of the cameras 25 may then preferably be given priority over other tuning options. If, however, the player or the audience member suddenly changes direction of movement, special effects such as “camera wobbling” and/or appropriate sound effects may be presented to the user 140. The special effects are useful for giving the effect that the user 140 is moving an actual camera which resists a change in its direction of motion while allowing the anticipatory processing system 100 to assign a higher priority to the camera field-of-view to which the player or audience member is now expected to enter.

If the player or audience member suddenly drastically increases speed, the anticipatory processing system 100 may change from assigning each next camera sequentially to assigning each second or third camera sequentially. For example, in an extreme case where someone is trying to track a supersonic jet flying past a number of fixed cameras, the anticipatory processing system 100 may assign priority sequentially to cameras 10, 12, 14, 16 etc and produce a blurring effect to simulate a single camera being moved very fast. A decision to skip over cameras may be based on information sent by the headend 20 or calculated by the anticipatory processing system 100 itself regarding the nature of the object being tracked, for example, speed of the object, or rate of change of camera ID numbers, or actual expected next camera ID numbers.

It is appreciated that a message indicating permission to be tracked that is sent by the audience member need not be directed to a specific STB. Rather, the message may be transmitted to a group of STBs to permit a specific group of users to track the audience member, the group including, for example, friends and family members of the audience member.

It is further appreciated that tracking of a person need not occur only at games or locations where special events take place. Rather, a person wishing to be tracked by the user 140 may use cameras in public places, such as shopping malls or tourist sites, to send a picture of himself and his surroundings to the STB 80 while making a telephone call to the user 140 via a cellular telephone. This may typically provide the user 140 with a much better view of an area in which the person is than a view provided by a cellular telephone camera.

Preferably, the cameras in the public places may be used to broadcast images to the STB 80, for example via the headend 20. Additionally, as mentioned above, a plurality of cameras in a single public place may be combined to give the user 140 an impression of manipulating a single camera or an impression of a single camera tracking the person.

One option is for the user 140 to only be able to view a channel associated with a camera in a public place that takes images of the person if the user 140 is actually speaking with the person when the person is in the public place. Such an option typically addresses and resolves privacy concerns.

Another option is for the user 140 to be able to view a channel associated with a camera in a public place that takes images of the person without being able to focus in on strangers in the public place without their permission In such a case, the headend 20 preferably matches up the person calling with the STB 80 in a manner as described above and provides the STB 80 with a permission to view the channel associated with the camera in a public place that takes the images of the person. The permission to view the channel may include, for example, an authorization to produce control words to decrypt encrypted broadcast material including the images of the person, or an authorization to tune to the channel.

Additionally or alternatively, a direct link may preferably be established between the cellular telephone of the person and the STB 80 before the STB 80 enables displaying of the channel in clear. It is appreciated that establishment of the direct link may be controlled or enforced by a device associated with the STB 80, such as the smart card 130. In such a case, the smart card 130 will not produce a valid control word if it does not receive information from a cellular telephone associated with the channel.

Further alternatively, the camera in the public place may transmit video images of the person to the cellular phone of the person in a case where the cellular telephone of the person has video capabilities. The cellular telephone of the person may then transmit the video images of the person, for example as part of a call session, to a receiving device (not shown). If the cellular telephone of the person includes the anticipatory processing system 100, the cellular telephone of the person may receive broadcasts from a plurality of public cameras, including video images and location data, and use anticipatory processing based on a direction of travel of the person to switch between camera outputs on transmission to the receiving device.

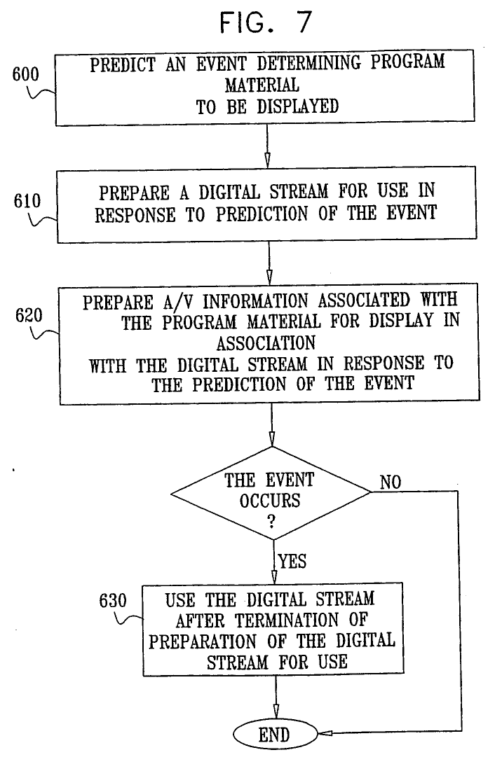

Reference is now made to FIG. 7 which is a simplified flowchart illustration of a preferred method of operation of the anticipatory processing system 100 of FIG. 2.

Preferably, an event determining program material to be displayed is predicted (step 600). Then, a digital stream is prepared for use in response to prediction of the event (step 610). Additionally, A/V information associated with the program material may preferably be prepared for display in association with the digital stream in response to the prediction of the event (step 620).

Preparing the digital stream for use preferably includes at least one of the following: preparing the digital stream for rendering; preparing the digital stream for storage; and preparing the digital stream for distribution via a communication network. After termination of preparation of the digital stream for use, the digital stream may preferably be used if the event occurs (step 630). Usage of the digital stream preferably includes at least one of the following: rendering of the digital stream; storage of the digital stream; and distribution of the digital stream via the communication network.

It is appreciated that if the digital stream is rendered, rendering of the digital stream is preferably performed at a time after termination of preparation of the digital stream for use. The time after termination of preparation of the digital stream for use may be immediately after termination of preparation of the digital stream for use or a later time.

Preferably, the A/V information is prepared for display in association with the digital stream by preparing the A/V information for display over a channel associated with the digital stream, or by preparing the A/V information for display together with the digital stream in a picture-in-picture (PIP) mode, or further by preparing the A/V information for display together with the digital stream in a side-by-side mode.

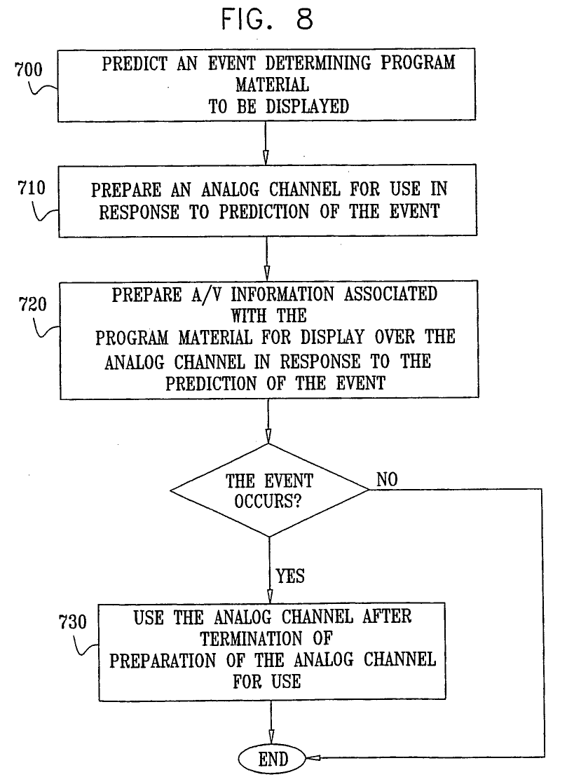

Reference is now made to FIG. 8 which is a simplified flowchart illustration of another preferred method of operation of the system 100 of FIG. 2.

Preferably, an event determining program material to be displayed is predicted (step 700). Then, an analog channel, such as an analog television channel, is preferably prepared for use in response to prediction of the event (step 710). A/V information associated with the program material may also preferably be prepared for display over the analog channel in response to the prediction of the event (step 720).

If the event occurs, then, after termination of preparation of the analog channel for use, the analog channel is preferably used (step 730) such as by rendering the analog channel over a television display, or by recording the A/V information and/or the program material in a VCR.

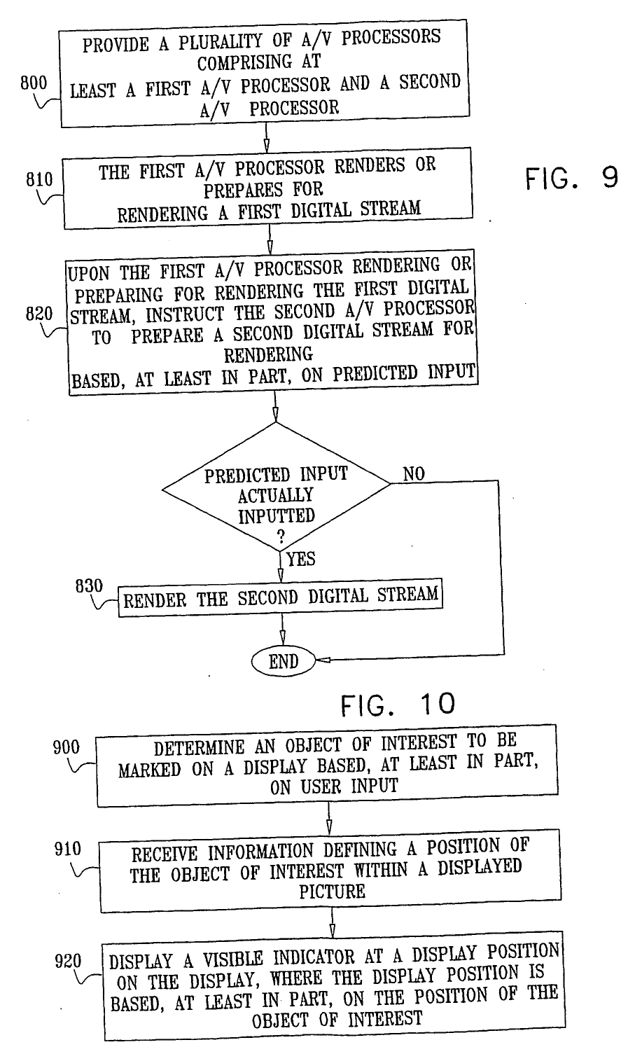

Reference is now made to FIG. 9 which is a simplified flowchart illustration of still another preferred method of operation of the system 100 of FIG. 2.

A plurality of A/V processors comprising at least a first A/V processor and a second A/V processor are preferably provided (step 800). Upon the first A/V processor rendering or preparing for rendering a first digital stream (step 810), the second A/V processor is preferably instructed (step 820) to prepare a second digital stream for rendering based, at least in part, on predicted input. It is appreciated that if the predicted input is actually inputted, the second A/V processor preferably renders the second digital stream (step 830).

Reference is now made to FIG. 10 which is a simplified flowchart illustration of a preferred method of operation of the display apparatus 110 of FIG. 6.

Preferably, an object of interest to be marked on a display is determined (step 900) based, at least in part, on user input. Information defining a position of the object of interest within a displayed picture is preferably received (step 910). Then, a visible indicator is displayed (step 920) at a display position on the display, where the display position is based, at least in part, on the position of the object of interest.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined only by the claims which follow:

1. An anticipatory processing system comprising:
a controller generating a prediction of an event determining program material to be displayed; and
an audio/video (A/V) processor controlled by the controller for preparing a digital stream for use in response to the prediction of the events
wherein the anticipatory processing system smoothes transition to the program material to be displayed from a presently viewed program.

2. The system according to claim 1 and wherein the A/V processor is also controlled by the controller for preparing A/V information associated with said program material for display in association with said digital stream in response to the prediction of the event.

3. The system according to claim 1 and wherein the A/V processor prepares the digital stream for use by performing at least one of the following: preparing the digital stream for rendering; preparing the digital stream for storage; and preparing the digital stream for distribution via a communication network.

4. The system according to claim 2 and also comprising a display unit displaying the A/V information associated with said program material in association with said digital stream if the event occurs.

5. The system according to claim 1 and wherein the A/V processor, operating under control of the controller, uses the digital stream at a time after termination of preparation of the digital stream for use if the event occurs.

6. The system according to claim 5 and wherein the time after termination of preparation of the digital stream for use is immediately after termination of preparation of the digital stream for use.

7. The system according to claim 1 and wherein said event comprises at least one of the following: user input; an indication of a commercial break; an instruction from a headend or a broadcast source; an instruction from a computer program predicting user behavior based on a user profile; an alert associated with a current display; and at least one message from a broadcaster or a service provider.

8. The system according to claim 1 and wherein said program material comprises a commercial.

9. The system according to claim 1 and wherein said program material comprises a segment of a television program.

10. The system according to claim 1 and wherein the digital stream is associated with a channel.

11. The system according to claim 10 and wherein the channel comprises one of the following: a regular channel; and a virtual channel.

12. The system according to claim 2 and wherein the A/V processor prepares the A/V information for display in association with the digital stream by performing at least one of the following: preparing the A/V information for display over a channel associated with the digital stream; preparing the A/V information for display together with the digital stream in a picture-in-picture (PIP) mode; and preparing the A/V information for display together with the digital stream in a side-by-side mode.

13. An anticipatory processing system comprising:
a controller generating a prediction of an event determining program material to be displayed; and
a tuner controlled by the controller for preparing an analog channel for use in response to the prediction of the event.

14. The system according to claim 13 and wherein the analog channel comprises an analog television channel.

15. The system according to claim 13 and wherein the tuner is also controlled by the controller for preparing A/V information associated with said program material for display over said analog channel in response to the prediction of the event.

16. The system according to claim 13 and wherein the tuner uses the analog channel if the event occurs.

17. An anticipatory processing system comprising:
a plurality of A/V processors comprising at least a first A/V processor and a second A/V processor; and
a controller controlling at least the first A/V processor and the second A/V processor and, upon the first A/V processor rendering or preparing for rendering a first digital stream, instructing the second A/V processor to prepare a second digital stream for rendering based, at least in part, on predicted input.

18. The system according to claim 17 and wherein the controller generates the predicted input based upon at least one of the following: user input; an indication of rendering or preparation for rendering of the first digital stream; an indication of a commercial break; an instruction from a headend or a broadcast source; an instruction from a computer program predicting user behavior based on a user profile; an alert associated with a current display; and at least one message indicating current or scheduled occurrence of an event.

19. The system according to claim 17 and wherein the controller comprises a stream selector for choosing any one of the first digital stream and the second digital stream from at least one of the following: a broadcast multiplex; and a plurality of digital content items stored in a memory.

20. The system according to claim 17 and wherein the second A/V processor, operating under control of the controller, renders the second digital stream after termination of preparation of the second digital stream for rendering if the predicted input is actually inputted.

21. The system according to claim 17 and wherein each of the plurality of A/V processors comprises a decoder for decoding an encoded data stream.

22. The system according to claim 21 and wherein the encoded data stream comprises an encoded video stream.

23. The system according to claim 22 and wherein the encoded video stream comprises an MPEG data stream and the decoder comprises an MPEG decoder.

24. The system according to claim 23 and wherein the MPEG data stream comprises an MPEG-2 data stream and the MPEG decoder comprises an MPEG-2 decoder.

25. The system according to claim 23 and wherein the MPEG data stream comprises an MPEG-4 data stream and the MPEG decoder comprises an MPEG-4 decoder.

26. The system according to claim 17 and also comprising a display unit operative to display at least one of the following: audio content; and video content.

27. The system according to claim 26 and wherein the audio content comprises audio content outputted by the first A/V processor and the video content comprises video content outputted by the first A/V processor.

28. The system according to claim 27 and wherein the display unit also displays video content outputted by the second A/V processor as picture-in-picture (PIP) images.

29. The system according to claim 17 and also comprising a content storage unit operative to store at least one of the following: audio content; and video content.

30. The system according to claim 29 and wherein the audio content comprises audio content outputted by the second A/V processor and the video content comprises video content outputted by the second A/V processor.

31. The system according to claim 29 wherein the controller retrieves from the content storage unit for display at least one of the following: audio content; and video content.

32. The system according to claim 18 and wherein the user input comprises user channel changes.

33. The system according to claim 32 and wherein the user channel changes comprise a channel change in a first direction, and the predicted input is one of the following: a channel change in the first direction; and a channel change in a direction opposite to the first direction.

34. The system according to claim 33 and wherein the first direction comprises exactly one of the following: an upward direction; and a downward direction.

35. The system according to claim 32 and wherein the user channel changes comprise changes between exactly one of the following: virtual channels; and regular channels.

36. The system according to claim 17 and wherein the controller determines at least one favorite channel based, at least in part, on the predicted input.

37. The system according to claim 17 and wherein the controller tracks a discrete object based, at least in part, on information concerning a path of the object.

38. The system according to claim 37 and wherein the discrete object comprises a person.

39. The system according to claim 38 and wherein the person comprises one of the following: an actor; a player; and an audience member.

40. The system according to claim 38 and wherein the controller tracks the person only upon receipt of an indication of at least one of the following: knowledge of the person; and permission of the person.

41. The system according to claim 40 and also comprising a processor receiving said indication from at least one of the following: the person directly; a broadcast source; and a headend.

42. The system according to claim 41 and wherein said indication is generated from an authorization list of parties with permission to track the person that is provided by the person, wherein the indication is generated at one of the following: the broadcast source; and the headend.

43. The system according to claim 37 and wherein the controller tracks the discrete object by processing images received from a plurality of cameras that together provide a panoramic view of the object, wherein each camera of the plurality of cameras provides a viewing range which is a subset of the panoramic view.

44. The system according to claim 17 and wherein the controller comprises a special-effects generator for locally producing special effects.

45. A cellular telephone comprising the system according to claim 1.

46. A cellular telephone comprising the system according to claim 13.

47. A cellular telephone comprising the system according to claim 17.

48. Display apparatus for marking an object of interest on a display, the apparatus comprising:
an object determiner determining the object of interest based, at least in part, on user input;
a position information receiver receiving, from a source remote to the display apparatus, information defining a position of the object of interest within a displayed picture; and
an on-screen display (OSD) unit displaying a visible indicator at a display position on the display, the display position being based, at least in part, on the position of the object of interest.

49. Apparatus according to claim 48 and wherein the information is sent from a broadcast source or a headend.

50. Apparatus according to claim 48 and wherein the information is addressed to at least one particular viewer.

51. A set-top box (STB) comprising the apparatus of claim 48, the STB being associated with at least one particular viewer who is authorized to view the object of interest, and being operative to receive the information via a telephone message.

52. Apparatus according to claim 48 and wherein the object of interest is operatively associated with identification (ID).

53. Apparatus according to claim 48 and wherein the object of interest comprises a person.

54. Apparatus according to claim 53 and wherein the person comprises one of the following: an actor; a player; and an audience member.

55. Apparatus according to claim 53 and wherein said position information receiver receives said information from the source remote to the display apparatus only upon generation of an indication of at least one of the following: knowledge of the person; and permission of the person.

56. Apparatus according to claim 55 and wherein said indication is generated at the source from an authorization list of parties with permission to track the person that is provided by the person.

57. Apparatus according to claim 53 and wherein said position information receiver receives via said source a permission from the person to be tracked.

58. Apparatus according to claim 53 and wherein the position information receiver receives an indication of a permission to be tracked directly from the person.

59. An anticipatory processing method comprising:
predicting an event determining program material to be displayed; and
preparing a digital stream for use in response to said predicting
wherein the anticipatory processing method smoothes transition to the program material to be displayed from a presently viewed program.

60. The method according to claim 59 and also comprising:
preparing A/V information associated with said program material for display in association with said digital stream in response to said predicting.

61. The method according to claim 59 and wherein said step of preparing the digital stream for use comprises preparing the digital stream for rendering.

62. The method according to claim 59 and wherein said step of preparing the digital stream for use comprises preparing the digital stream for storage.

63. The method according to claim 59 and wherein said step of preparing the digital stream for use comprises preparing the digital stream for distribution via a communication network.

64. The method according to claim 59 and also comprising using the digital stream if the event occurs.

65. The method according to claim 64 and wherein said step of using comprises at least one of the following: rendering the digital stream; storing the digital stream; and distributing the digital stream.

66. The method according to claim 65 and wherein said rendering comprises rendering the digital stream at a time after termination of preparation of the digital stream for use.

67. The method according to claim 66 and wherein the time after termination of preparation of the digital stream for use is immediately after termination of preparation of the digital stream for use.

68. The method according to claim 60 and wherein said preparing A/V information for display in association with said digital stream comprises at least one of the following: preparing the A/V information for display over a channel associated with the digital stream; preparing the A/V information for display together with the digital stream in a PIP mode; and preparing the A/V information for display together with the digital stream in a side-by-side mode.

69. An anticipatory processing method comprising:
predicting an event determining program material to be displayed; and
preparing an analog channel for use in response to said predicting.

70. The method according to claim 69 and also comprising preparing A/V information associated with said program material for display over said analog channel in response to said predicting.

71. The method according to claim 69 or claim 70 and also comprising using the analog channel if the event occurs.

72. The method according to claim 71 and wherein said step of using comprises at least one of the following: rendering the analog channel over a television display; and recording the program material in a VCR.

73. An anticipatory processing method comprising:
providing a plurality of A/V processors comprising at least a first A/V processor and a second A/V processor; and
instructing the second A/V processor, upon the first A/V processor rendering or preparing for rendering a first digital stream, to prepare a second digital stream for rendering based, at least in part, on predicted input.

74. The method according to claim 73 and also comprising rendering the second digital stream if the predicted input is actually inputted.

75. A display method for marking an object of interest on a display, the method comprising:
determining the object of interest based, at least in part, on user input;
receiving information defining a position of the object of interest within a displayed picture; and
displaying a visible indicator at a display position on the display, the display position being based, at least in part, on the position of the object of interest.

76. An anticipatory processing system comprising:
predicting means for predicting an event determining program material to be displayed; and
preparing means for preparing a digital stream for use in response to said predicting means,
wherein the anticipatory processing method means smoothes transition to the program material to be displayed into a presently viewed program.

77. An anticipatory processing system comprising:
predicting means for predicting an event determining program material to be displayed; and
preparing means for preparing an analog channel for use in response to said predicting.

78. An anticipatory processing system comprising:
providing means for providing a plurality of A/V processing means comprising at least a first A/V processing means and a second A/V processing means; and
instructing means for instructing the second A/V processing means, upon the first A/V processing means rendering or preparing for rendering a first digital stream, to prepare a second digital stream for rendering based, at least in part, on predicted input.

79. Display apparatus for marking an object of interest on a display, the apparatus comprising:
determining means for determining the object of interest based, at least in part, on user input;
receiving means for receiving information defining a position of the object of interest within a displayed picture; and
displaying means for displaying a visible indicator at a display position on the display, the display position being based, at least in part, on the position of the object of interest.

80. The system according to claim 4 and wherein the A/V processor prepares the A/V information for display in association with the digital stream by performing at least one of the following: preparing the A/V information for display over a channel associated with the digital stream; preparing the A/V information for display together with the digital stream in a picture-in-picture (PIP) mode; and preparing the A/V information for display together with the digital stream in a side-by-side mode.

81. The system according to claim 18 and wherein the controller comprises a stream selector for choosing any one of the first digital stream and the second digital stream from at least one of the following: a broadcast multiplex; and a plurality of digital content items stored in a memory.

82. The system according to claim 30 wherein the controller retrieves from the content storage unit for display at least one of the following: audio content; and video content.
